(19) United States
(12) Patent Application Publication
(10) Pub. No.: US 2011/0295611 A1
(43) Pub. Date: Dec. 1, 2011

(54) Method, process and apparatus for preserving biological materials and information concerning biological materials for the use of descendants and future generations.

(76) Inventor: Gelu Comanescu, Washington, DC (US)

(21) Appl. No.: 13/118,450

(22) Filed: May 29, 2011

Related U.S. Application Data
(60) Provisional application No. 61/349,867, filed on May 30, 2010.

(51) Int. Cl. G06Q 30/00

(52) U.S. Cl. 705/1.1

(57) ABSTRACT

We present a method, process and apparatus for preserving biological materials and information concerning biological materials for the use of descendents and future generations. The method can be implemented as a service provided to various parties such as persons, institutions, organizations, associations etc. The purpose of this invention is to provide a method consists essentialy of keeping the biological materials that these parties want (e.g. said party's DNA, blood tissue, muscle tissue, bone tissue donated by the certain donor) such that these materials are made available for the use of future generation and descendents of such parties as far in the future as possible. Another purpose of this invention is to provide a prcoess consisting essentially of performing scientific, medical and genetic investigations of the said biological materials and keeping the obtained information for the use of the donor and for the use of future generations.

### CROSS-REFERENCES TO RELATED APPLICATIONS

Under 35 U.S.C. §119(e), this application claims the benefit of priority of U.S. Provisional Patent Applications filed by inventor Gelu Comanescu as follows: No. 61/349867 filed on May 30, 2010 (EFS ID 7714436, confirmation number 1424). The contents of the provisional application are incorporated by reference in their entirety.

### FIELD OF INVENTION

The present invention relates to a process and method for providing a service to parties that leads to preserving and perpetuating biological materials delivered by said parties as far into the future as possible and making such materials and the information associated with them available to descendants and future generations as far away into the future as possible.

### BACKGROUND OF INVENTION

Information about the medical history and genetic background of a person's ancestors is of significant medical value both to the particular person and to the society in general. Conversely, a currently living person would like to make available to their descendants (as far away into the future as possible) genetic information and information about their health background. Such information is useful to the descendants in particular and to society in general.

A person can make his/her genetic background available to future generations in two ways: first, by performing genetic sequencing of his Deoxyribonucleic Acid (hereinafter “DNA”) and other investigations and storing the obtain sequence information and other results in digital form on a data storage media such as a hard-disks or compact disks, then the data holding the said person's DNA sequence would be made available to future generations; and second, by ensuring that the future generations receive or have genetic/biological materials (such as blood stains, bone, skin cells) from the said person.

For the sake of clarity we will refer to a specific fictional case. Consider John born in year 2000; his descendants Sarah born in year 2100; and Alice born in year 2200. John would like that Sarah and Alice have John's DNA sequence because this sequence gives important information about the genetic diseases Sarah and Alice are predispose to develop, about various health information and about other background information of their ancestry. There are two ways John can make this information available to his descendants. First, John can have his DNA sequenced and the sequence stored on a data storage media such as a hard-disks and compact disks, then the data holding John's DNA sequence would be made available to future generations (e.g. Sarah and Alice) by various means (e.g. the service described in the U.S. Provisional Patent application No. 61/345719 filed on May 18, 2010; and the U.S. patent application Ser. No. 13/107890 filed on May 15 2011). Second, John can find a method to store biological material containing his DNA (e.g. by encapsulating a piece of bone or blood drop in a container or by embedding such materials in a material such as plastic, raisin or amber), then the future generations will have biological materials from John and perform a DNA sequencing on that material.

The first option is less feasible because at this time the technology of DNA sequencing is not well developed and sequencing is prohibitively expensive. The second method is much more likely to be successful because it is very likely that in the next hundreds of years the technology of DNA sequencing will develop such that DNA sequencing will become affordable and feasible. Therefore, the strategy to make your DNA sequence available to future generations is to leave them DNA containing biological materials and let them do the sequencing when the sequencing technology matures and becomes cheaper. Once the DNA sequencing is performed the administrator of the service will keep the information obtained by sequencing and other investigation procedures for the subsequent future generations.

Biological DNA offers a very compact way of keeping large amounts of information in very small quantity of material. It is likely that a data-storage media, such as a Hard Disk holding someone's DNA sequence occupies much more space than the biological material. There are other logistic reasons why it is easier to store and preserve directly the DNA biological materials than to store and preserve the corresponding data-storage media. When biological materials from storage are exhausted (descendants use the materials for sequencing) copies of the DNA can be made by Polymerase Chain Reaction or other procedures and replenish the biological materials stored in a capsule.

A person can make his or her genetic background available to future generations by ensuring that the future generations receive or have genetic materials (such as blood stains, bone, skin tissue, muscle tissue etc.) from said person. The said person would store DNA containing materials in a way that is known to preserve DNA for long time (i.e. embedded in amber, or encapsulated in titanium or gold capsule). The box containing DNA material can be given to his/her descendants with the hope that descendants will keep it and give it further to their descendants. This approach has the shortcoming that the number of descendants a person has over time increases a lot: in 200 years a person likely has about 150 descendants.

Another approach is to have a party that takes on the task (provides a service) of keeping the capsules for long time and make them available to future generations for sequencing. Keeping and preserving such capsules containing biological materials is likely very cheap because the capsules are small and the value for future generations of such capsules is high.

The party that keeps the biological materials can also take on the task of performing various genetic and biological investigations (e.g. DNA genome sequencing) on the stored biological materials as technology evolves and such investigation procedures become available and affordable. The party that keeps the biological materials will store the information obtained by these investigation procedures in digital form on behalf of the donor and on behalf of other interested parties.

### SUMMARY OF INVENTION

(1). The offer to provide a service and the contractual agreement.

The party practicing the invention (also referred hereinafter as the “administrator” or “service provider”) advertises and offers a service to various parties (e.g. people, private parties, institutions, organizations, associations of all kinds) whereas the administrator acquires biological materials from said parties, stores and preserves said materials with the purpose of making them available to descendants and future generations for their use; and performs scientific, medical and genetic investigations of the materials and keeps the obtained information for the use of the donor and for the use of future generations.

The party practicing the invention employs a means for making the following contractual offer to various parties (also referred hereinafter as “donors”) with the intention of performing the promise: the party practicing the invention promises to take steps (including but not limited to the ones described at sections 2-9 below) to ensure that the biological materials provided by customers and the associated information will be kept for the use of future generations (as long as possible, or for certain period of time) and to ensure that the kept materials will be made available to the future generations according to customer's specifications (e.g. only to customer's descendants, or to health organizations, or to any interested party); and to perform scientific, medical and genetic investigations of the materials and keep the obtained information for the use of future generations. The above promise is performed upon customer providing the party offering the service (practicing the invention) with the materials that customer wants to be perpetuated and kept for the use of future generations and upon performing other promises such as paying a fee.

Such a means for making an offer includes but is not limited to making an offer over the internet by an on-line service, in newspapers, on television, on the radio, or any other ways. Such a means for entering in such contractual agreement includes but is not limited to contract signed via an on-line service and via signed paper.

(2). Collection of biological materials.

The party practicing the invention employs a means for collecting the biological materials from customers with the following purposes: (a). keeping and perpetuating them for the use of future generations; (b). performing scientific, medical and genetic investigations of the materials and keeping the obtained information for the use of future generations. Based on biological and medical studies, the administrator will indicate the tissue types to be collected (e.g. blood, bone, skin, muscle); the quantities necessary for each type of tissue, and will indicate a collection procedure and a procedure for sending such tissue from customer to the service provider. Tissue can be collected from live person or death person. Different procedures of collection apply whether the subject is dead or alive.

The party practicing the invention employs a means for offering customers a collection kit consisting essentially of: (1). biological tissue storage containers; (2). Description of collection procedures; (3). Forms where the customer specifies: the identity of the party materials come from, who is authorized to use the biological materials, the contract, and other information describing and associated with the collected biological materials; (4). A mailing or transport box to send the containers with biological tissue to the service provider.

(3). Performing studies and investigation on the received biological materials and obtaining various medical, scientific and other types of information

The service provider will use part of the biological materials received from the donor to perform various genetic and biological investigations on these materials (as technology allows and according to the contractual agreement). The remaining biological materials are kept for storing (see sections 4-9 below). The service provider will store the information obtained by these investigation procedures in digital form as associated with the biological materials on behalf of the donor and such that this information can be used by future generations.

(4). Preparing biological materials for storage and storing said materials.

Once the service provider receives the biological materials from the customer, the service provider will take steps to prepare the materials for storage. Based on biological and medical studies the service provider will process the biological materials such as to ensure they survive (do not degrade) for long time. The various types of biological materials (i.e. blood, bone tissue, muscle tissue) can be individually stored in various types of enclosures or embedded in materials that are known to preserve DNA (i.e. amber, polymers). A strategy that may be employed is to form mixtures of the various types of tissue and to store such mixtures in various enclosures or to store them embedded in various types of materials.

Various procedures and strategies of achieving preservation of such biological materials can be employed. Various procedures and strategies can be employed in storing the biological materials, embedding them and in forming assembly capsules containing individual enclosures. These strategies are commensurate with the financial investment (the fee) the customer is willing to make.

The various biological materials containing enclosures and embedded materials can be further assembled in capsules. Each capsule will hold biological materials from a particular customer. Capsules from individual customers can be either handed to the customer and his assignees or the administrator takes on the task to preserve them for future generation. The administrator will store and organize the capsules from individual customers in arrays. The administrator will form and keep records of the stored capsules.

A “description file” (i.e. digital text file) will be formed for each capsule describing the components of the capsule (i.e. what type of tissue is stored in each compartment), the identity of the biological material donor, and other information to be preserved and transmitted to future generations. The “description file” will be stored on a small permanent memory chip integrated or stored with the capsule. The administrator will also keep this description file for his records in order to be able to find a specific capsule among the many other capsules administrator keeps in storage. The administrator will also give the “description file” to customer and his assignees.

(5) Forming records and keeping track of the stored biological materials.

The party practicing the invention employs a means for keeping track of all the biological materials stored and kept for the use of future generations. The administrator will maintain records with all the biological materials stored (i.e. the capsules) and the corresponding “description files” such that future generation can find biological materials from a certain donor (i.e. their ancestors). Such record will keep information identifying the donor such as: the name, date of birth, residence, record index number, and the various places where the preserved biological materials from that donor are stored.

These records keeping track of biological materials coming from a certain donor can be linked to the records keeping other type of information about the same donor (e.g. the service described in the U.S. Provisional Patent application No. 61/345719 filed on May 18, 2010; and the U.S. patent application Ser. No. 13/107890 filed on May 15 2011).

(6). Means for keeping, preserving and perpetuating the biological materials.

The party practicing the invention employs a means for keeping the biological materials under physical conditions (e.g. temperature, radiation, humidity) known to preserve DNA and other biological materials, protected against natural disasters, and using other means ensuring that the biological materials are preserved for long time and can be used by future generations.

The party practicing the invention employs a means for keeping multiple types of capsules with biological material from one donor such that if one type of capsule fails in time the others survive. This way the survival and perpetuation of the materials for long time is ensured. Such capsules can be small.

The party practicing the invention employs a means for storing the capsules from one donor in multiple places (e.g. U.S. National Archives cryogenic room; a glacier in Greenland; a glacier in Antarctica; Australia; on the bottom of the ocean; on the moon etc.). This way if something happens in a certain part of the world (e.g. natural disasters, political changes, accidents) and some materials are lost in one part of the world copies of said materials from the same person survive somewhere else.

(7). Performing studies and investigation on the stored biological materials and obtaining various medical, scientific and other types of information

The party that keeps the biological materials can also take on the task of performing various genetic and biological investigations (e.g. DNA sequencing) on the stored biological materials as technology evolves and such investigation procedures become available and affordable. The party that keeps the biological materials will store the information obtained by these investigation procedures in digital form on behalf of the donor and on behalf of other interested parties according to the contractual agreement between donor and service provider.

(8). Procedures and strategies to preserve, copy, multiply, and perpetuate the stored materials and the information they hold.

The party practicing the invention will employ means to reproduce and make copies of the biological materials. For example, DNA can be multiplied and copied by Polymerase Chain Reaction (PCR). This way the materials into the capsules can be replenished (when there is a risk they will deplete) and the information these materials hold will be perpetuated.

The party practicing the invention will employ a means to store the genetic and health information obtained from DNA sequencing and other investigation procedures performed on the biological materials. The information obtained by DNA sequencing and other investigations will be kept in digital form, on various digital storage media, and will be kept associated with the biological materials and the donor. For instance, such information can be stored on a miniature memory which is kept in the same capsule with the biological materials. Whenever new information is obtained about said biological materials, the information will be stored (added/appended) on said memory. Also, the information associated with a certain donor can be linked (or added/appended) to the records keeping other type of information about the same donor (e.g. personal information), such as the records kept by the service described in the U.S. Provisional Patent application No. 61/345719 filed on May 18, 2010; and the U.S. patent application Ser. No. 13/107890 filed on May 15 2011.

(9). Making the stored biological materials and the information associated with them available to interested parties at various times in the future.

The service provider employs a means to make the biological/genetic materials available to future generations according to the donor specifications and following the policies and procedures specified by the donor. The administrator of the service acts as donor's trustee. A very likely scenario is that over the next hundreds of years various descendants of the donor and other interested parties (e.g. health and research organizations) will sequentially remove and use biological materials stored in donor's capsules and deplete the stored materials.

Unlike data stored on a hard-disk which is not exhaustible (you can give copies of the data to lots of people) biological materials are exhaustible (if you keep on taking materials from the capsule to give it to descendants the materials will be used up). If descendants in the following 100 years use up the biological materials in the capsule (imprudently, for no serious reason) their descendants won't have any such materials available. Accordingly, clear policies must be set in the contract between the service provider and donor such that the stored biological materials are used judiciously. For instance, a sensible policy would be that the biological materials inside a capsule (i.e. donated by one person) should never be completely exhausted, and an interested party should remove the minimum amount of materials necessary, multiply them (e.g. by PCR), then put back into the capsules copies of such materials.

Biological materials and information associated with them will be made available to interested parties upon satisfying various conditions such as paying a fee. Various strategies can be employed to ensure availability of biological materials and information associated with them to future generations: copies of the records can be provided to Governmental and other organizations such as the National Archives with the provision to be made available for the use of future generations.

The party practicing the invention may promise to take steps towards perpetuation of the biological materials and associated information even if this party (e.g. corporation, association, organization, private parties) does not survive. For instance, the party offering the service may be a corporation which at a certain time into the future goes bankrupt. The biological materials and associated information it keeps are still valuable assets which can be sold or transferred to someone else. A provision is added in the contract that if the party practicing the invention does not survive or can no longer preserve and administer the materials (e.g. goes bankrupt) the party will transfer the biological materials and associated information to whoever is interested to preserve them.

Various means, strategies, and levels of sophistication and expense can be implemented to ensure that the biological materials and associated information survive for long time and accomplish the purpose of providing valuable information to the future generations. Various levels of efforts, expense and means can be used to accomplish this purpose. Consequently, the more financial resources and effort is invested the more likely that the materials and the records survive longer and are more accessible to future interested parties.

There are numerous circumstances that indicate that information kept in this way will be perpetuated over long times. The amount of biological materials necessary to perform DNA sequencing is very small (milligrams), therefore the donor capsules can be designed to be very small. DNA has been shown to survive when embedded in amber for thousands of years. It is inexpensive for whoever runs such a service and has custody over biological materials to keep/preserve them and almost certainly she will be able to sell to someone the information generated by materials and part of such materials and cover its cost. Government organizations (e.g. the National Institute of Health) are interested in such materials. The cost of maintaining and perpetuating the materials and the generated information is low and likely much lower than the money its owner can derive from it.

Various type of parties can submit biological samples they need kept over long periods of time: private persons (the most interested); scientific institutions and organization; health institutions; companies; Governments etc. Such a service and records would be particularly useful to Medical and Scientific Research. The service can be used for preserving human biological materials, non-human biological materials (e.g. animals, plants, bacteria), and the information associated with such materials.

### DESCRIPTION OF THE BEST MODE

(1). The offer to provide a service and the contractual agreement.

The party practicing the invention advertises and offers a service to various parties (e.g. persons, institutions, organizations, associations of all kinds) whereas the administrator acquires biological materials from said parties, stores and preserves said materials with the purpose of making them available to descendants and future generations for their use; and performs scientific, medical and genetic investigations of the materials and keeps the obtained information for the use of the donor and for the use of future generations.

The party practicing the invention makes the following contractual offer to various parties (also referred hereinafter as “donors”) with the intention of performing the promise: the party practicing the invention promises to take steps to ensure that the biological materials provided by customers will be kept for the use of future generations and to ensure that the kept materials will be made available to the future generations according to customer's specifications (e.g. only to customer's descendants, or only to health organizations, or only for certain purpose). The above promise is performed upon customer providing the party offering the service with the materials that the customer wants to be perpetuated and kept for the use of future generations and upon performing other promises such as paying a fee.

(2). Collection of biological materials.

The party practicing the invention collects the biological materials from customers with the following purposes: (a). keeping and perpetuating them for the use of future generations; (b). performing scientific, medical and genetic investigations of the materials and keeping the obtained information for the use of future generations. The administrator will collect 1 gram of each of the following types of tissue: blood, bone, skin, and muscle. At the request of the customer the administrator may collect and store other type of tissue. The administrator accepts tissue either from live person or dead person.

The administrator offers customers a collection kit consisting essentially of: (1). Biological tissue storage containers; (2). Description of collection procedures; (3). Forms where the customer specifies: the identity of the donor, who is authorized to use the biological materials, the contract, and other information describing and associated with the collected biological materials; (4). A mailing or transport box to send the containers with biological tissue to the service provider.

(3). Preparing biological materials for storage and the storing in capsules.

Once the service provider receives the biological materials from the customer, the service provider will take the following steps to prepare the materials for storage: Each type of material received (blood, bone tissue, muscle tissue, skin tissue) will be cut in 9 pieces. Three of the nine pieces will be stored in a gold mini-capsule (2 mm diameter spheres); three of the nine pieces will be embedded in amber beads; three of the nine pieces will be embedded in polymer beads. Three titanium capsules (about 0.5 cubic centimeters) will store the gold mini-capsule and beads. Each capsule will contain: 4 gold mini-capsule (each containing blood, muscle, skin and bone); 4 amber beads (each containing blood, muscle, skin and bone); 4 polymer beads (each containing blood, muscle, skin and bone).

Upon request by customer, some capsules will be handed to the customer and his assignees. The administrator takes on the task to keep and preserve the remaining capsules for future generation. The administrator will store and organize the capsules from individual customers in cabinet arrays. The administrator will form and keep records of the stored capsules.

A “description file” will be formed for each capsule describing the components of the capsule (type of tissue is stored in each compartment), the identity of the biological material donor, and other information to be preserved and transmitted to future generations. The “description file” will be stored in a digital form on a small permanent memory chip integrated or stored with the capsule. The administrator will also keep this description file for his records in order to be able to find a specific capsule among the many other capsules administrator keeps in storage. The administrator will also give the “description file” to customer and his assignees.

(4) Forming records and keeping track of the stored biological materials.

The administrator will keep track of all the biological materials stored. The administrator will maintain records with all the capsules and the corresponding “description files” such that future generation can find biological materials from a certain donor (e.g. their ancestors). Such record will keep the following information: the name, date of birth, residence of the donor; record index number; and indicate the various places where the preserved biological materials from that donor are stored.

The records that keep track of biological materials coming from a certain donor will be linked to the records keeping other type of information about the same donor such as the records of the service described in the U.S. Provisional Patent application No. 61/345719 filed on May 18, 2010; and the U.S. patent application Ser. No. 13/107890 filed on May 15, 2011.

(6). Keeping, preserving and perpetuating the biological materials.

The party practicing the invention keeps the biological materials at temperatures below freezing, low humidity, and protected from radiation.

The party practicing the invention keeps multiple capsules with biological material from one donor such that if one capsule fails in time the other ones survive. The party practicing the invention stores the three capsules from one donor in multiple places: U.S. National Archives cryogenic room; a glacier in Greenland; and a glacier in Antarctica. This way if something happens in a certain part of the world (i.e. natural disasters, political changes, accidents) and materials are lost in one part of the world they survive somewhere else. The party practicing the invention will keep records of all the places where the capsules are stored.

(7). Making the stored biological materials and the information associated with them available to interested parties at various times in the future.

The party practicing the invention makes the biological/genetic materials available to future generations according to the donor specifications. The administrator of the service acts as donor's trustee. Biological materials and information associated with them will be made available to interested parties upon satisfying various conditions such as paying a fee and according to the specifications of the donor.

As the biological materials in a certain capsule are used up, the party practicing the invention will reproduce and make copies of the biological materials as technology at that time allows (e.g. by Polymerase Chain Reaction). This way the materials into the capsules are replenished and the information these materials hold will be perpetuated.

The party practicing the invention will store the genetic and health information obtained from DNA sequencing and other investigation procedures performed on the biological materials. The information obtained by DNA sequencing and other investigations will be kept in digital form on digital storage media and will be kept associated with the biological materials and the donor. This information associated with a certain donor will be linked (or added/appended) to the records keeping other type of information about the same donor (e.g. personal information), such as the records kept by the service described in the Provisional Patent application No. 61345719 filed by Gelu Comanescu (same inventor as in this application) on May 18, 2010.

The party practicing the invention promises to take steps towards perpetuation of the biological materials and associated information even if this party (e.g. corporation, association, organization, private parties) does not survive such as keeping a certain amount of funds available for close up costs. If the party practicing the invention does not survive or can no longer preserve and administer the biological materials (e.g. goes bankrupt) the party will transfer the biological materials and associated information to whoever is interested to preserve them.

Although the present invention has been described with respect to the preferred embodiment, numerous modifications and variations can be made and still the result will come within the scope of the invention. No limitation with respect to the specific embodiment disclosed herein is intended or should be inferred.

1. A method for keeping and perpetuating biological materials collected from one or more donors and information relating to said biological materials and making said biological materials and said information available to descendants of said donors and to future generations, wherein one or more of the following conditions are satisfied:
(a) said donors know that said biological materials and said information will be kept and perpetuated with the purpose of making said materials and said information available to descendants of said donors and to future generations,
(b) keeping and perpetuating of said materials and said information is performed upon request by said donors,
(c) relatives or agents or representatives of said donors are aware that said biological materials and said information are kept and perpetuated with the purpose of making said materials and said information available to descendants of said donors and to future generations,
(d) said donors are neither celebrities nor privileged persons nor public figures,
(f) society does not have more reasons to keep and perpetuate information about said donors than to keep and perpetuate information about any other person,
(g) said keeping and perpetuation of said materials and said information is performed upon request by a relative, or a representative, or an agent of said donors,
(h) said keeping and perpetuating of said materials and said information is performed in consideration for an action performed by said donors or agents of said donors,
(i) said keeping and perpetuating of said materials and said information is performed as part of a contract, or a commercial transaction, or an agreement with said donors or with agents of said donors,
(j) the cost to the donor or his agents for having said materials kept and perpetuated does not exceed the average monthly salary in the United States,
(k) the cost to the donor or his agents for having said materials kept and perpetuated does not exceed half of the average monthly salary in the United States,
(l) the cost to the donor or his agents for having said materials kept and perpetuated does not exceed three six times the average monthly salary in the United States;
and wherein the method comprises:
(a) receiving said biological materials collected from said donors and receiving said information associated with said biological materials;
(b) keeping and perpetuating said materials and said information as far as possible into the future, or for at least 50 years, or for an unlimited period of time;
(c) keeping account of said biological materials and said information;
(d) making said materials and said information available to interested parties into the future or at any time.

2-3. (canceled)

4. A method for keeping and perpetuating biological materials provided by one or more parties and information relating to said biological materials and for making said biological materials available to future generations, wherein one or more of the following conditions are satisfied:
(a) said parties are aware that said biological materials and said information will be kept and perpetuated with the purpose of making said materials and said information available to future generations,
(b) said keeping and perpetuating of said materials and said information is performed upon request by said parties,
(c) said keeping and perpetuating of said materials and said information is performed in consideration for an action performed by said parties or with by agents of said parties,
(d) said keeping and perpetuating of said materials and said information is performed as part of a contract, or a commercial transaction, or an agreement with said parties or with agents of said parties;
and wherein the method comprises:
(a) receiving said biological materials and said information;
(b) keeping and perpetuating said materials and said information as far as possible into the future, or for at least 50 years, or for an unlimited period of time;
(c) keeping account of said materials and said information;
(d) making said materials and said information available to interested persons into the future or at any time.

5. The method of claim 1, wherein keeping and perpetuating said biological materials and said information includes at least one of the following procedures:
(a) storing said biological materials inside enclosures, such as capsules and containers, or embedded in embedding materials wherein said enclosures and embedding materials are known or expected to preserve the materials for long time;
(b) storing said biological materials inside multiple types of enclosures or embedded in multiple types of embedding materials;
(c) storing said information on one or more data storage media wherein said types of data storage media are known to last for long time;
(d). storing multiple types of biological materials such as blood tissue, bone tissue, muscle tissue, and brain tissue;
(e) storing multiple samples of biological materials coming from the same donor;
(f) storing multiple samples of the same type of biological materials collected from each individual donor;
(g) making multiple copies of said information and storing said copies on multiple data storage media;
(h) copying said information from a first data storage media to a new data storage media before the expiration or depreciation of said first storage media;
(i) making copies of said biological materials before said materials depreciate or are depleted;
(j) keeping said information stored on data storage media which (in turn) are further stored in environmental conditions that are known to increase the survival of the data storage media and of the data stored on the data storage media;
(k) keeping said biological materials in environmental conditions that are known to increase the survival of said biological materials;
(m) keeping multiple copies of said information on multiple data storage media which in turn are stored in multiple places in the universe;
(n) keeping samples of biological materials collected from a donor in multiple places in the universe;
(p) surrendering said biological materials and said information to parties capable of further keeping and perpetuating said biological materials and said information;
(r) performing investigations on said biological materials and storing the results of said investigations in association with the information associated to said biological materials;
(q) performing investigations on said biological materials and storing the results of said investigations in association with the information associated to said biological materials, as investigation procedures become available and affordable.

6. The method of claim 4, wherein keeping and perpetuating said biological materials and said information provided by said parties includes at least one of the following procedures:
(a) storing said biological materials inside enclosures, such as capsules and containers, or embedded in embedding materials wherein said enclosures and embedding materials are known or expected to preserve the materials for long time;
(b) storing said biological materials inside multiple types of enclosures or embedded in multiple types of embedding materials;
(c) storing said information on one or more data storage media wherein said types of data storage media are known to last for long time;
(d) storing multiple types of biological materials such as blood tissue, bone tissue, muscle tissue, and brain tissue;
(e) storing multiple samples of biological materials coming from the same donor;
(f) making multiple copies of said information and storing said copies on multiple data storage media;
(g) copying said information from a first data storage media to a new data storage media before the expiration or depreciation of said first storage media;
(h) making copies of said biological materials before said materials depreciate or are depleted;
(i) keeping said information stored on data storage media which (in turn) are further stored in environmental conditions that are known to increase the survival of the data storage media and of the data stored on the data storage media;
(j) keeping said biological materials in environmental conditions that are known to increase the survival of said biological materials;
(l) keeping multiple copies of said information on multiple data storage media which in turn are stored in multiple places in the universe;
(m) surrendering said biological materials and said information to parties capable of further keeping and perpetuating said biological materials and said information;
(n) performing investigations on said biological materials and storing the results of said investigations in association with the information associated to said biological materials;
(o) performing investigations on said biological materials and storing the results of said investigations in association with the information associated to said biological materials, as investigation procedures become available and affordable.

7. The method of claim 5 wherein information identifying said donors is kept associated with said biological materials.

8. The method of claim 5 wherein said biological materials are kept in enclosures and wherein individual enclosures hold biological materials collected from an individual donor.

9. The method of claim 8 wherein a data storage media is attached to each enclosure.

10. The method of claim 8 wherein said enclosures contain identifying information of said donor associated with said enclosure.

11-13. (canceled)

14. The method of claim 1, wherein said biological materials and said information are made available to parties other than said donors only if making said materials and said information available to said parties satisfies the conditions, desires, and restrictions expressed by said donors or by agents and representatives of said donors.

15. The method of claim 4, wherein said biological materials and said information are made available to third parties different from the parties providing said materials and said information only if making said information available to said third parties satisfies the conditions, desires, and restrictions expressed by the party providing said biological materials and said information.

16. (canceled)

17. The method of claim 1, wherein said interested parties are provided with a family tree associated with said donor.

18-19. (canceled)
